(19) United States
(12) Patent Application Publication
(10) Pub. No.: US 2009/0081104 A1
(43) Pub. Date: Mar. 26, 2009

(54) Control of ceramic microstructure

(75) Inventors: Robert Ibsen, Santa Maria, CA (US); Xiaohui Chen, Santa Maria, CA (US); Michael J. Cattell, Santa Maria, CA (US); Jacques V. Riodel, Santa Maria, CA (US); Thomas C. Chadwick, Nipomo, CA (US)

Correspondence Address: CROWELL & MORING LLP;INTELLECTUAL PROPERTY GROUP, P.O. BOX 14300, WASHINGTON, DC, 20044-4300, US

(73) Assignee: Den-Mat Holdings LLC, Santa Maria, CA (US)

(21) Appl. No.: 11/902,496

(22) Filed: Sep. 21, 2007

(51) Int. Cl. C01B 33/26

(52) U.S. Cl. 423/328.2

(57) ABSTRACT

The present invention provides for the production of a single frit, dental porcelain, glass-ceramic containing small, uniformly dispersed, single leucite crystals of ellipsoidal habit and very uniform size.

### FIELD OF THE INVENTION

The present invention relates generally to dental ceramics. In particular, the invention relates to a low wear, dental glass-ceramic that contains very uniform, ellipsoidal reinforcing leucite crystals and a process for making it

### BACKGROUND OF THE INVENTION

The use of porcelain facings or veneers (also called porcelain laminates) to cover unsightly teeth and thereby improve their appearance was pioneered by Dr. Charles Pincus in 1928. Dr. Pincus fabricated his porcelain veneers by firing packed dental porcelain powder on platinum foil.

Because of the limited range of adhesives available at the time, veneers were cemented in place only temporarily. Because of their expense and the limitations imposed by the available adhesives, porcelain veneers were used primarily by movie stars during performances before the camera (for a detailed account of the early history of porcelain veneers see: J. Cosmetic Dentistry, 1 (3), 6-8 (1985)).

During the 1970's great improvements were made in the area of dental adhesives, and the use of porcelain veneers became popular among the general public. Because of the limitations in the strengths of existing porcelain, the technique of building a metal substructure and firing porcelain to the outside was also developed. Although this technique was successful and useful, it had its limitations. Paramount among the difficulties associated with porcelain-metal restorations was the need to match the coefficient of thermal expansion of the porcelain and the underlying metal and the need to opacify heavily the porcelain, so that the metal substructure would remain well hidden. The use of porcelain-fused-to-metal construction also made it possible to fabricate more complicated structures, such as porcelain jacket crowns and bridges, but the previously mentioned problems and the difficulty of bonding metal reliably to tooth structure made all-porcelain restorations a desirable goal.

In order to avoid the need for a metal substructure, much effort has been directed to strengthening dental porcelain. Attempts to strengthen dental porcelain have usually involved the inclusion of strengthening oxide particles in the base porcelain. Examples of strengthening oxides include zirconium oxide and aluminum oxide. The inclusion of strengthening oxides opacifies the porcelain and makes simultaneous control of opacity and strength impossible.

An ideal porcelain for the fabrication of all-porcelain veneers, crowns and bridges should possess high strength. Ideally, it should possess the strength of the metal-oxide-reinforced porcelains. It should be available in a range of opacities which ideally could run from very opaque to clear. The coefficient of thermal expansion of the porcelain should match the coefficients of thermal expansion of the bonding agents and underlying teeth. It should be available in a variety of shades, and the colorants should be incorporated in, rather than painted on, the porcelain.

Finally, the porcelain should be easy to fabricate by either the platinum foil or refractory model fabrication techniques. It should not show a pronounced tendency to separate during the initial firing, and any separation cracks that do form should heal easily rather than separate further. The maturing temperature should be below 1093° C. (2000° F.) to avoid any unnecessarily severe service for the vacuum furnaces. As a final point, the coefficient of thermal expansion should be less than 15×10⁻⁶° C.⁻¹ in order to avoid difficulty in matching refractory expansion to that of the porcelain.

Glass-ceramics containing leucite are known. A number of patents discuss the importance of controlling either the volume fraction of leucite in leucite-containing glass-ceramics or the size distribution of the leucite crystallites. Some patents discuss the need to control both, but none of them discuss methods for control of crystal size. EP00155564 and U.S. Pat. No. 4,604,366 discuss the importance of controlling the amount of leucite to control the thermal expansion of these materials, but they do not discuss desirable sizes of leucite crystals nor do they discuss control of crystal size. EP0272745, U.S. Pat. No. 4,798,536; U.S. Pat. No. 6,428,614; U.S. Pat. No. 6,761,760; and US patent applications US20030122270 and US20040121894 each mention that the leucite crystallites should be less than 35 microns and in some cases preferably less than 5 microns but they do not describe how these crystallite sizes are achieved. U.S. Pat. No. 6,527,846 describes rod-like leucite crystals 0.3-1.5 microns wide and 7-20 microns in length but provides no indication of how to control the size of these rods. U.S. Pat. No. 5,653,791; U.S. Pat. No. 5,944,884; and U.S. Pat. No. 6,660,073 all discuss leucite glass-ceramics containing leucite crystals less than 10 microns in size but do not indicate the method of size control. Patents JP23048770, U.S. Pat. No. 6,706,654 and US patent application US20020198093 all describe a leucite glass-ceramic and lithium disilicate glass-ceramic blend in which the leucite is created from added leucite seed crystals. The role of leucite seed crystal size in determining the strength of the ceramic is discussed but there is no mention of the influence of glass particle size on ceramic properties. With the exception of U.S. Pat. No. 6,527,846, none of these patents discusses leucite crystal morphology.

U.S. Pat. No. 5,009,709, assigned to Den-Mat Corporation, describes a dental porcelain that was useful for application in refractory techniques, however, this patent does not discuss leucite or any method for controlling leucite crystal size. The present invention describes how to control leucite crystal size in a glass of that composition by controlling various processing variables. World patent application WO 00/48956 (abandoned) described a porcelain composition similar to that described in U.S. Pat. No. 5,009,709 that was useful for preparing dental restorations by the lost wax pressing technique. Again, this application did not describe any means for controlling the size of the leucite crystals in the finished glass-ceramic.

### SUMMARY OF THE INVENTION

The present invention provides for the production of a single frit, dental porcelain, glass-ceramic containing small, uniformly dispersed, single leucite crystals of ellipsoidal habit and very uniform particle size. The powdered glass-ceramic can be used with the platinum foil or refractory investment technique to produce dental restorations or it can be pressed and sintered into blocks or ingots and used in a variation of the lost wax casting technique or CAD/CAM techniques to produce restorations.

One embodiment of the invention encompasses a method of making a leucite containing glass-ceramic comprising preparing a leucite-free glass, grinding the glass to the desired particle size in order to control the size of the leucite crystal in the finished ceramic, and refiring to produce the glass-ceramic.

Another embodiment of the instant invention encompasses a method of controlling the particle size distribution of leucite in a glass-ceramic composition comprising blending glass-ceramic precursors until the precursors are well mixed, firing the glass-ceramic precursor mixture at a temperature above the liquidus for leucite, holding the mixture at a the temperature above the liquidus for leucite for 2-10 hours, allowing the mixture to cool to room temperature thereby forming a leucite-free glass frit, grinding the leucite-free glass frit to a desired particle size in order to control the particle size of the leucite in the finished glass-ceramic, firing the ground leucite-free glass frit to a temperature below the liquidus for leucite, and cooling until a leucite containing glass-ceramic is formed.

A further embodiment of the instant invention encompasses a single frit, dental porcelain, glass-ceramic containing small, uniformly dispersed, single leucite crystals of ellipsoidal habit and very uniform size.

### BRIEF DESCRIPTION OF THE FIGURES

FIG. 1 shows a leucite glass-ceramic produced by a method in accordance with the instant invention.

FIG. 2 shows a leucite glass-ceramic produced by a method in accordance with the instant invention.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

The present invention provides for the production of a single frit, dental porcelain, glass-ceramic containing small, uniformly dispersed, single leucite crystals of ellipsoidal habit and very uniform particle size. The powdered glass-ceramic can be used with the platinum foil or refractory investment technique to produce dental restorations or it can be pressed and sintered into blocks or ingots and used in a variation of the lost wax casting technique or CAD/CAM techniques to produce restorations.

Such a glass-ceramic is expected to cause only very low wear rates on opposing teeth without sacrificing strength, thermal or optical properties. Furthermore the average particle size of leucite crystals and the abrasivity of the leucite glass-ceramic can be controlled over a wide range of size by controlling the particle size of the leucite-free glass that is the precursor to the glass-ceramic. The process of the present invention avoids the need to make and then rapidly quench glass precursors that other processes use and it avoids the need a separate glass powder heat treatment step employed by other methods such as those described by Brodkin in U.S. Pat. Nos. 6,090,194; 6,120,591; 6,133,174; and 6,155,830.

It has been discovered that a single-frit, leucite-containing, glass-ceramic containing leucite crystals of uniform and selectable size can be produced via a two-step fritting process. In the first step suitable components for the production of a glass of the correct chemical composition are mixed and fired to produce the glass. Although potassium feldspar is the major ingredient for the usual method of production, other raw materials can be used for the preparation of the glass. Other minerals, pure chemicals or sol-gel precursors would all function perfectly well for the production of the leucite-free glass with the only requirement being that the raw materials have the correct overall chemical composition to produce the glass. After the glass precursors have been fired to produce the glass in the first firing, the glass is then ground and refired to produce the glass-ceramic. The glass powder can be shaped by compressing the powder in a die and firing directly to produce a dental glass-ceramic ingot for fabricating dental restorations by hot pressing or CAD/CAM. Alternatively the glass powder can be fired in bulk to produce chunks of dental glass-ceramic that can be crushed and ground to a powder and used in the stackable porcelain technique with either platinum foil or refractory investment models to produce porcelain restorations such as veneers, inlays, onlays and crowns or the powder can be pressed in a die and sintered to produce porcelain ingots that can be used to fabricate dental restorations by either the hot pressing or CAD/CAM techniques.

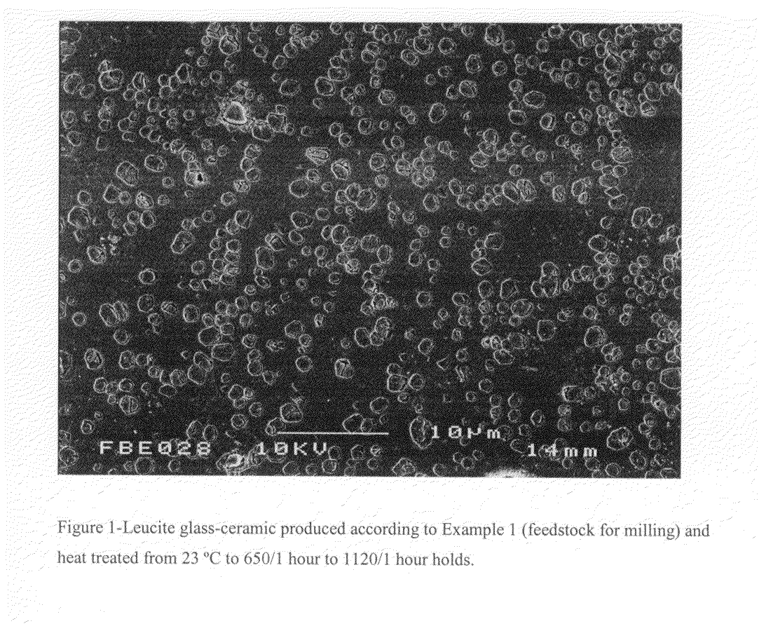

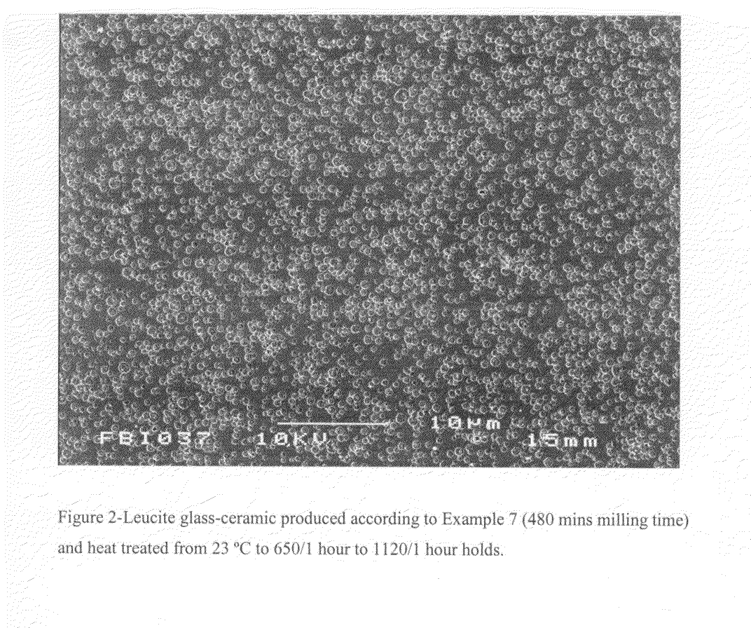

The production of single frit glass-ceramics containing uniformly dispersed single leucite crystals of reproducible, selectable and controllable size relies on several discoveries. First, it has been discovered that the control of leucite particle size in the finished glass-ceramic relies on the production of glass in the first firing stage that is leucite-free or nearly so. For our purposes here the term leucite-free means that there is no detectable leucite when powdered glass from the first firing is examined by powder x-ray diffraction. The detection limit by this technique for leucite in a glass matrix is less than 1% (w/w). The control of the particle size distribution also relies on the discovery that there is a direct relationship between the particle size distribution of the powdered glass that is made from the glass produced in the first firing and the particle size distribution of leucite crystals in the finished glass-ceramic. Thus it is possible to produce small leucite crystals in the finished glass-ceramic if the glass from the first firing is ground to a fine particle size (see FIG. 2) and it is possible to produce larger leucite crystals if coarser glass powder is produced and used to make the glass-ceramic (see FIG. 1). The rapid production of small uniform leucite crystals also relies on the discovery that crystal nucleation and growth are quite rapid and can be done within the context of a firing that does not require a hold time at the nucleation temperature (600-700° C.). Although it is possible to exert additional control by halting at the nucleation temperature range it is not necessary to do so. This feature facilitates the rapidity and throughput of the process without compromising the ability to produce leucite crystals in a specific size range.

The invention provides

1) a glass-ceramic with reinforcing crystals of leucite where the leucite crystal size can be easily controlled

2) a glass-ceramic that exhibits high flexural strength

3) a glass-ceramic, which contains small, uniform, ellipsoidal reinforcing leucite crystals, and which has low abrasivity toward the natural enamel of opposing teeth

4) a simple method of glass-ceramic production consisting of the steps of producing a leucite-free glass followed by grinding the glass to the desired degree of fineness (selected to control the particle size of the leucite in the finished ceramic) and refiring to produce the glass-ceramic.

5) a method of glass-ceramic production in which it is unnecessary to heat the glass batch to a temperature sufficiently high to allow the glass to be poured into water.

6) A glass-ceramic that, by virtue of uniformly sized, ellipsoidal crystals, low crystal loading and low viscosity residual glass has a very broad temperature range (1000-1100° C.) over which it can be processed by hot pressing.

7) a low wear glass-ceramic which, when processed by the CAD/CAM technique, promotes machine tool longevity.

One embodiment of the invention begins with selecting suitable starting materials to make the leucite-free glass. The most convenient starting material, and the ingredient that contributes the majority of material to the glass, is high potassium feldspar. Feldspar with a chemical composition consisting of silica, 64-68%, alumina, 17-19%, calcium oxide, 0.1-1.0%, potassium oxide, 9-11%, and sodium oxide, 2-4% is satisfactory. The commercial material, G-200 Feldspar, presently produced by The Feldspar Corporation, a subsidiary of ZEMEX Industrial Minerals, Inc., supplied with a mean particle size of approximately 12 microns is quite useful. The second ingredient is a glass consisting of silica, 54-58%, alumina 5-9%, sodium oxide, 4-8%, potassium oxide, 18-22%, magnesium oxide, <4%, and calcium oxide, <4%. The third ingredient is another glass containing silica, 42-48%, alumina 0-2%, sodium oxide 18-22%, calcium oxide, <4%. The fourth ingredient is lithium carbonate. The particle size of the two glasses and the lithium carbonate should be similar to that of the feldspar.

The preparation of the leucite-free glass is accomplished by the usual methods of ceramic fabrication. The ingredients are weighed and then placed in a powder blender such as a twin cone or V cone blender and the ingredients are mixed to produce a uniform, homogenous powder. After the powders are a homogenous blend they are packed in refractory containers and fired to a temperature of at least 1300° C. and preferably 1350° C. and held at that temperature until a uniform, leucite-free melt is produced. This usually requires between 2 and 10 hours to accomplish. After the ingredients are thoroughly fused, the contents of the furnace are allowed to cool. The firing produces blocks of glass that are cleaned by sandblasting. After cleaning, the blocks are then crushed in a jaw crusher, screened to remove impurities from the crushing operation and then ground in a ball mill to produce glass powder with a mean particle size of approximately 25 microns.

The desired mean size of leucite crystals in the finished glass-ceramic can be selected using two equations.

For glass powder with a mean diameter above 3.5 microns the relationship between mean glass powder diameter and leucite crystal mean equivalent spherical diameter is described by:

mean leucite crystal diam, microns=0.0117×mean glass powder diameter, microns+0.8931

For glass powder with a mean diameter at or below 3.5 microns the relationship between mean glass powder diameter and leucite crystal mean equivalent spherical diameter is described by:

mean leucite crystal diam, microns=0.1463×mean glass powder diameter, microns+0.3792

The mean particle size of leucite-free glass feedstock is determined and the glass powder is wet ground to correct size in a Union Process attritor mill or other similar mill capable of reducing particle size into the 10 micron to 0.5 micron range. After the desired particle size is reached, the slurry of water and glass powder is discharged from the mill, the water is removed, the glass powder is dried by suitable means and the powder is then screened through a 325 mesh US series screen to remove agglomerates.

At this point, two alternatives can be used to produce the finished glass-ceramic. In the first alternative, the ground, powdered glass-ceramic precursor is mixed with opacifiers such as titanium oxide, zirconium oxide, zirconium silicate or tin oxide and single or multiple ceramic pigments that are necessary to give the glass-ceramic its proper final shade and opacity and the blended powders can then be pressed in a die to produce a powder compact. The powder compact can then be rapidly fired to 1120° C. to directly produce finished ingots that are suitable for use in hot pressing or CAD/CAM processes for the production of dental restorations.

Alternatively, the ground glass powders can be blended with opacifiers such as titanium oxide, zirconium oxide, zirconium silicate or tin oxide as well as individual ceramic pigments, packed in large refractory containers and the powder can be refired to 1120° C. The refractory containers are then removed from the furnace while hot and cooled rapidly in air. The resulting chunks of opacified, colored leucite glass-ceramic are then crushed and milled to produce a variety of glass-ceramic powders of different basic colors. These powders can then be blended to produce glass-ceramic powders of the correct final shade and opacity. These blended powders can be used directly to produce dental restorations by the stackable technique or the powder can be die pressed and sintered rapidly enough to preclude changes to the microstructure of the glass-ceramic so that ingots suitable for making dental restorations by the pressable technique or CAD/CAM technique can be produced. This latter process simplifies the problem of producing proper porcelain shades while the former process requires fewer steps to produce pressable, machineable ingots.

Note that the second firings associated with either process alternative can be modified to include a 0.50 to 4.0 hour hold at temperatures ranging from 600° C. to 700° C. These holds do allow some additional control over the nucleation process but they are not indispensable for satisfactory results.

The method of the present invention employs a two step process for the manufacture of a leucite containing glass-ceramic wherein the particle size distribution of leucite crystals in the product glass-ceramic is controlled to very narrow distributions over a wide range of average particle sizes. In the first step porcelain glass-ceramic precursors selected from naturally occurring feldspar, glasses of appropriate composition or metal oxides, carbonates, nitrates in any combination that will provide the correct elemental composition for the glass-ceramic are blended, if the components are already finely divided, or ground and blended if they are not, until the precursor mixture is homogenous and well mixed. The precursor mixture is then placed in a container of cordierite, mullite, silica or other suitable refractory and fired to a temperature above the liquidus for leucite, which in the compositional system of the present invention is approximately 1300° C. The mixture is held at this temperature for 2-10 hours, the holding period providing an opportunity to allow dissolution of the starting materials as well as any leucite that has crystallized during the heating process. After the holding period the mixture is allowed to cool slowly to room temperature. The leucite-free glass frit is obtained as solid, unfractured blocks, which are cleaned, crushed and reground to carefully controlled particle sizes that are selected to provide the desired leucite particle size in the final glass-ceramic. After grinding, the powders are dried (if a wet grinding process is employed), blended with pigments and opacifiers such as titanium dioxide, tin oxide, zirconium oxide, zirconium silicate or other equivalent materials and pressed into powder compacts. These powder compacts can then be fired from room temperature to 1120° C. at heating rates up to 10° C./min. A hold time of 0.50 to 4.0 hours in the temperature range including 600° C. to 700° C. may be optionally included so that additional control may be exerted over the nucleation of leucite crystals. When the upper temperature has been reached, the sintered compacts are removed from the furnace and allowed to air cool.

Alternatively, the blended powders may be processed in bulk. The powders can be placed in cordierite saggers that have been coated with a 3 mm layer of 50 micron tabular alumina powder. The cordierite saggers are fired to 1100° C. at average rates of 2.0-3.5° C./min and held at the high temperature for 45 minutes. After the holding period the containers holding the glass-ceramic are withdrawn immediately from the furnace and allowed to cool in air. When the glass-ceramic has cooled it is removed as chunks from the container, the chunks are cleaned and then crushed, ground and sieved. Different colored powdered glass-ceramics may be produced by this method and the different shades of powder can then be blended to produce the shades required for dental restoration manufacture. The blending of basic shades makes the process of shade matching much simpler than if the powders are produced to a specific shade by adding concentrated pigments directly to the ceramic.

### EXAMPLE 1

### Preparation of the Leucite-Free Glass

All raw ingredients were obtained and used as powders (−325 mesh, US Series screen) A batch (˜27 Kg) of frit was prepared by blending 22.226 Kg powdered potassium feldspar (composition of SiO₂, 66.3%, Al₂O₃, 18.50%, Na₂O, 3.04%, K₂O, 10.75%, CaO, 0.81% and MgO, 0.05%) with 3.922 Kg of a first glass powder (SiO₂, 55.4%, Al₂O₃, 7.19%, Na₂O, 6.68%, K₂O, 20.2%, MgO, 1.92%, CaO, 8.32%, SrO, 0.05%, BaO, 0.22% and TiO₂, 0.02%), 0.534 Kg of a second glass powder (SiO₂, 46.6%, Al₂O₃, 0.615%, B₂O₃, 6.09%, MgO, 0.052%, CaO, 4.83%, SrO, 2.57%, BaO, 10.5%, Na₂O, 17.0%, K₂O, 0.22%, TiO₂, 9.46%, F, 3.65%) and 0.334 Kg of powdered lithium carbonate. After the raw materials were thoroughly blended the powder mixture was packed into square cordierite saggers (25 cm width and length and 8.5 cm deep)) that had previously been coated with a 3 mm layer of tabular alumina (50 micron average particle size). The saggers were then stacked into an electric furnace, fired rapidly to 1316° C. and held at that temperature for 7 hours. Power was shut off to the furnace after the hold period and the furnace was allowed to cool to room temperature over 2 days. After cooling, the glass was removed from the saggers as intact blocks, the blocks were cleaned of aluminum oxide by sandblasting and the blocks were then crushed to 1-5 cm chips. These chips were then ball milled to produce a powdered glass with an average particle size of 11.4 microns. The powdered frit was examined by Dr. Sampeth Iyengar, Technology of Materials, Wildomar, Calif. (XRD analysis by the Rietveld technique) and Dr. Michael Cattell (XRD), Barts and the London Queen Mary's School of Dentistry, London, England and both confirmed that there was no detectable leucite (i.e. leucite content was <1%) in the ground glass. The yield of ground frit was 22 Kg.

### EXAMPLES 2, 3, 4, 5 And 6

### Preparation of Frit Specimens Ground to Different Particle Sizes

The frit of example 1 was used as the feedstock for the preparation of more finely ground glass powder. Grinding was carried out in a Union Process Attritor Mill (Union Process, 1925 Akron-Peninsula Road, Akron, Ohio 44313), Model 1-S. The mill was equipped with a 1 gallon water-jacketed grinding chamber, was driven by a 2 horsepower electric motor equipped with a variable speed drive and the grinding chamber was charged with 12.21 Kg of 5 mm spherical yttria stabilized zirconia grinding media. The particle size distributions of all ground ceramic powders were characterized with a Mastersizer/E particle analyzer (Malvern Instruments, UK).

### EXAMPLE 2

The grinding chamber of the 1-S attritor was charged with 2.000 Kg of the glass frit of Example 1 and 2550 mL of distilled water. The mill agitator was run at 600 rpm for 30 minutes and the frit slurry was discharged to four Pyrex dishes and dried at 122 oC for 48 hours to yield 1.902 Kg of glass powder with a mean particle size of 4.73 microns.

### EXAMPLE 3

Following Example 1, the grinding chamber was charged with 2.000 Kg of the glass frit of Example 1 and 2550 mL of distilled water. Milling was continued for 45 minutes and the slurry was processed in a fashion similar to Example 2 to yield 1.935 Kg of ground glass powder with a mean particle size of 3.54 microns.

### EXAMPLE 4

The grinding chamber of the 1-S attritor was charged with 2.000 Kg of the glass frit of Example 1 and 2550 mL of distilled water. Milling was continued for 60 minutes and the slurry was processed to give 1.878 Kg of ground glass powder with a mean particle size of 3.02 microns.

### EXAMPLE 5

The grinding chamber of the 1-S attritor was charged with 2.000 Kg of the glass frit of Example 1 and 2550 mL of distilled water. Milling was continued for 90 minutes and the slurry was processed to give 1.876 Kg of ground glass powder with a mean particle size of 3.02 microns.

### EXAMPLE 6

The grinding chamber of the 1-S attritor was charged with 2.000 Kg of the glass frit of Example 1 and 2550 mL of distilled water. Milling was continued for 120 minutes and the slurry was processed to give 1.662 Kg of ground glass powder with a mean particle size of. 2.76 microns.

### EXAMPLE 7

A Union Process DMQ-07 small media mill equipped with a magnesia stabilized zirconia grinding chamber, yttria-stabilized zirconia impeller discs and 1589 g (0.429 L) of 0.65 mm yttria-stabilized zirconia grinding media was charged with 1.520 Kg of glass frit (11.4 microns average particle size) and 1.520 Kg of distilled water. The mill was run at 3700 rpm for 480 minutes. The mill contents were discharged at the end of the grinding period and the water was evaporated to yield glass frit with a mean particle size of 0.43 microns.

### General Procedure for Crystallization of Leucite

Powder compacts of the milled powders were prepared by pressing the powders in a die at 3 bar for one minute. The powder compacts were then fired to 1120° C. at a rate of 10° C./min. The firing was interrupted by a one-hour hold at 650° C. When the high temperature was reached the sintered glass-ceramic compacts were removed from the furnace and allowed to cool. The leucite crystal size distributions in the glass-ceramic derived from the powders of Examples 1-7 were determined by analysis of scanning electron microscope images taken of each sample. The powder size and leucite crystal size are summarized in the table presented below. For photomicrographs of glass-ceramics prepared from the coarsest and finest glass powders see FIG. 1 and FIG. 2, respectively.

| | Mean Glass Powder Size, | Leucite Crystal Size, Mean |
|---|---|---|
| Milling Time, | Mean Equivalent Spherical | Equivalent Spherical |
| minutes | Diameter, microns | Diameter, microns |
| 0 | 11.37 | 1.02 |
| 30 | 4.73 | 0.959 |
| 45 | 3.54 | 0.945 |
| 60 | 3.02 | 0.910 |
| 90 | 3.02 | 0.821 |
| 120 | 2.76 | 0.777 |
| 240 | 1.84 | 0.659 |
| 480 | 0.43 | 0.438 |

Powdered glass-ceramics as well as blends of different colored glass-ceramics, prepared as described above, may be used to fabricate dental restorations by the stackable refractory or platinum foil techniques or the blended powder can be compressed in a die and the resulting powder compacts can be sintered to produce ingots for use in dental restoration fabrication by hot pressing or CAD/CAM machining.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A method of making a leucite containing glass-ceramic comprising:
preparing a leucite-free glass;
grinding the glass to the desired particle size in order to control the size of the leucite crystal in the finished ceramic; and
refiring to produce the glass-ceramic.

2. The method of claim 1, wherein the desired particle size is less than 15 microns.

3. The method of claim 1, wherein the desired particle size is less than 5 microns.

4. The method of claim 1, wherein the desired particle size is less than 4 microns.

5. The method of claim 1, wherein the desired particle size is less than 3 microns.

6. A method of controlling the particle size distribution of leucite in a glass-ceramic composition comprising:
blending glass-ceramic precursors until the precursors are well mixed;
firing the glass-ceramic precursor mixture at a temperature above the liquidus for leucite;
holding the mixture at a the temperature above the liquidus for leucite for 2-10 hours;
allowing the mixture to cool to room temperature thereby forming a leucite-free glass frit;
grinding the leucite-free glass frit to a desired particle size in order to control the particle size of the leucite in the finished glass-ceramic;
firing the ground leucite-free glass frit to a temperature below the liquidus for leucite;
cooling until a leucite containing glass-ceramic is formed.

7. The method of claim 6, wherein the precursor mixture is fired to a temperature of approximately 1300° C.

8. The method of claim 6, wherein the ground leucite-free glass frit is fired to a temperature of approximately 1120° C.

9. The method of claim 8, further comprising the step of holding the temperature of the ground leucite-free glass frit at 600 to 700° C. for 0.1 to 4.0 hours during the firing process.

10. The method of claim 6, wherein the desired particle size is less than 15 microns.

11. The method of claim 6, wherein the desired particle size is less than 5 microns.

12. The method of claim 6, wherein the desired particle size is less than 4 microns.

13. The method of claim 6, wherein the desired particle size is less than 3 microns.

14. The method of claim 6, wherein the glass-glass ceramic precursors are selected from a group comprising feldspar, glass, metal oxides, carbonates, and nitrates.

15. The method of claim 6, further comprising the step of adding pigments and opacifiers to the

16. A glass-ceramic containing leucite crystals of ellipsoidal habit and very uniform size.

17. The glass-ceramic of claim 16, wherein the leucite crystals are less than one micron in size.

18. The glass-ceramic of claim 16, wherein the leucite crystals are less than one half of one micron in size.

19. A method of making a leucite containing glass-ceramic comprising:
preparing a glass having less than 1% leucite;
grinding the glass to the desired particle size in order to control the size of the leucite crystal in the finished ceramic; and
refiring to produce the glass-ceramic.
